(19) United States
(12) Patent Application Publication
(10) Pub. No.: US 2009/0160898 A1
(43) Pub. Date: Jun. 25, 2009

(54) METHOD AND APPARATUS FOR CONTROLLING NON-NUCLEATING HEATING IN A FLUID EJECTION DEVICE

(76) Inventors: Steven Wayne Bergstedt, Winchester, KY (US); David Golman King, Shelbyville, KY (US); Gregory Scott Woods, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/960,997

(22) Filed: Dec. 20, 2007

(51) Int. Cl. B41J 29/00

(52) U.S. Cl. 347/17; 347/9

(57) ABSTRACT

A method is described for controlling the temperature of a fluid ejection head is a fluid ejection apparatus. The fluid ejection head includes heating elements for generating fluid-nucleating heat for fluid ejection purposes and for generating non-fluid-nucleating heat (NNH) for temperature control purposes. The fluid ejection head has heating elements disposed in a plurality of zones distributed across the fluid ejection head. The heating elements are assigned to a plurality of address groups that are activated during corresponding address windows. The method includes generating a bit intensity word corresponding to each zone, where the bit intensity word specifies a sequence for activating the address groups for generating NNH. Each bit of the bit intensity word controls the activation of a corresponding address group during a corresponding address window. The high or low states of each bit in each of the bit intensity words are determined so that the address groups activated during the address windows are evenly distributed over the zones of the fluid ejection head to substantially balance the distribution of electrical current applied for non-fluid-nucleating heating across the zones.

### FIELD

The invention relates to the field of fluid ejection devices such as may be used in printing operations. More particularly, this invention relates to an apparatus and method for heating a fluid ejection head using non-nucleating heating pulses applied to fluid ejection elements.

### BACKGROUND

In the design of thermal inkjet printers, it is important to preheat the printhead chip of the printhead to a predetermined operating temperature before the printhead chip is used in a printing operation. If the printhead chip is not preheated and the proper operating temperature maintained, print quality suffers. Printhead preheating may be achieved by using what is typically referred to as a substrate heater. Another way is to use the ink ejecting heaters to heat the chip. This is done by applying an electrical pulse having a duration which is too short to generate enough heat to eject ink, but which is sufficient to heat the substrate at an acceptable rate to achieve the desired operating temperature within an acceptable amount of time. This latter method is referred to as “Non-Nucleating Heating” (or NNH). The techniques described herein are directed to the NNH method of heating.

NNH is an advantageous method of heating because it does not require additional area on the printhead chip that would be occupied by a substrate heater. Also, the NNH method heats the printhead chip directly in the area of interest—the ink firing chamber.

One concern with using the ink ejecting heaters to preheat the printhead is that the life of the heaters may be reduced due to additional use and activity. To address this concern, an NNH healing scheme should generate the heating pulses in such a way as to minimize individual heater stress, thereby maximizing printhead life. One way to minimize heater stress on individual heaters is to balance the application of energy across all heaters on the printhead.

When NNH is applied uniformly across a printhead chip, there may be instances when most or all of the non-printing heaters are involved. Applying NNH pulses simultaneously to many heaters on the chip can cause excessive current in the chip. It has been found that excessive currents in an inkjet heater chip can cause noise-related data integrity problems and shortened heater life. Therefore, it is desirable to minimize peak currents in the healer chip while generating NNH pulses.

Heater chips that pull large amounts of current while generating printing pulses (referred to herein as “fires”) or NNH pulses are susceptible to inductive chip ground bounce. For example, some heater chips are capable of up to 80 simultaneous fires leading to a peak current of over 7 Amperes. An important aspect of heater chip design is ensuring that activated heaters receive a precisely controlled amount of energy. This leads to the need for sharply defined rise and fall times on the signals that turn the heater power FET's on and off.

The time taken to turn an FET on and off also affects the duration of total on-time of the FET to apply the precise amount of energy needed for good print quality. In many heater chips, the allowable on-time provided for by each address window is quite short. As a result, the rise and fall times of the FET's must be as short as possible to allow for the maximum amount of energy to be delivered to the activated heaters in the shortest possible span of time. The rapid onset of current (typically within ˜25 ns) associated with the short rise times causes the inductive ground bounce.

There is a certain amount of unavoidable inductance in a the electrical wires and traces that provide connection to the heater chip. The voltage across an inductor is determined by:

v=L(di/dt),

As the current rise-time decreases, di/dt increases, and so does the voltage across the inductance formed by the wires and traces connecting to the heater chip. This voltage manifests itself as a sharp positive voltage spike (ground bounce) seen at the ground input, of the chip. The ground bounce problem is depicted graphically in the oscilloscope traces shown in FIGS. 7 and 8. Generally, the internal voltage power rails rise along with the ground bounce. However, the external digital inputs to the heater chip are referenced to a distant ground that is not subject to the ground bounce of the heater chip. As the heater chip ground bounces, the switch point of the chip input logic rises relative to the amplitude of the input signals. This change in switch point causes data corruption which results in printing errors. As shown in FIG. 8, a 2-volt ground bounce with a 3-volt input causes glitches in the internal clock signal resulting in data corruption.

What is needed, therefore, is an NNH control method that balances the application of energy across all heaters on the printhead and minimizes peak currents in the heater chip while generating NNH pulses. Also needed is an NNH control method that minimizes inductive chip ground bounce.

### SUMMARY

The above and other needs are met by a method for controlling the temperature of a fluid ejection head in a fluid ejection apparatus, where the fluid ejection head includes a plurality of heating elements for generating fluid-nucleating heat for fluid ejection purposes and for generating non-fluid-nucleating heat (NNH) for temperature control purposes. The method is used, in a fluid ejection head having heating elements that are disposed in n number of zones distributed across the fluid ejection head and assigned to m number of address groups. Each address group is activated during a corresponding address window. The method includes (a) generating n number of bit intensity words to specify an activation sequence for activating the m number of address groups of heating elements for generating non-liquid-nucleating heat, and (b) activating the address groups of heating elements according to the sequence specified by the n number of bit intensity words.

In some embodiments of the invention, each bit intensity word has a width of w number of bits, where each bit of the bit intensity word controls the activation of a corresponding address group during the corresponding address window. The high or low states of the bits in each of the bit intensity words are determined so that the address groups activated during the address windows are evenly distributed over the zones of the fluid ejection bead to substantially balance the distribution of electrical current applied for non-fluid-nucleating heating across the zones.

In some embodiments, the method includes generating the n number of bit intensity words to provide the non-fluid-nucleating heat at a heating intensity level. HI, according to:

$$HI = \frac{a}{w} \times 100 \% ,$$

where a is a total number of bits in a high state and w is the width in bits of the bit intensity words.

In cases where n is six (six zones in the fluid ejection head), no more than one zone is activated during any one address window at heating intensity levels of about 11% or less, no more than two zones are activated during any one address window at heating intensity levels of about 33% or less, no more than three zones are activated during any one address window at heating intensity levels of about 44% or less, no more than four zones are activated during any one address window at heating intensity levels of about 56% or less, and no more than five zones are activated during any one address window at heating intensity levels of about 67% or less.

In some embodiments wherein die heating elements are assigned to number of primitive groups, step (b) includes activating the primitive groups for non-nucleating heating in a predetermined sequence with a time delay between the activation of each primitive group.

In another aspect, the invention provides a method for controlling the temperature of a fluid ejection head in a fluid election apparatus. This method is applicable to a fluid ejection head that includes a plurality of beating elements for generating fluid-nucleating heat for fluid ejection purposes and for generating non-fluid-nucleating heat for temperature control purposes. The heating elements are assigned to p number of primitive groups, where all of the primitive groups are activated by a single NNH signal. The method includes (a) generating the NNH signal for producing non-fluid-nucleating heat in the fluid ejection head, and (b) providing a time delay in the NNH signal between each primitive group so that the primitive groups are activated by the NNH signal sequentially rather than simultaneously. The sequential activation reduces peak current applied to the fluid ejection head and the corresponding detrimental effects of ground bounce.

In yet another aspect, the invention provides an apparatus for controlling the temperature of a fluid ejection head in a fluid ejection device. The apparatus includes a plurality of heating elements for generating fluid-nucleating heat for fluid ejection purposes and for generating non-fluid-nucleating heat for temperature control purposes. The heating elements are distributed into p number of primitive groups. The apparatus also includes p number of activation signal lines, each connected to a corresponding one of the p number of primitive groups. An NNH input is connected to the p number of activation signal lines. The NNH input receives an NNH signal which, causes activation of the heating elements to produce non-fluid-nucleating heat. The apparatus includes a plurality of delay buffers, at least one of which is provided between each of the activation signal lines. Each delay buffer provides a time delay in the activation signal between each primitive group so that the primitive groups are activated by the activation signal sequentially rather than simultaneously. The delay buffers thereby reduce peak current applied to the fluid ejection head and the corresponding detrimental effects of ground bounce.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a fluid ejection head according to an embodiment of the invention;

FIG. 2 depicts an inkjet printer according to an embodiment of the invention;

FIG. 3 depicts a cross-section view of a fluid ejection chamber and heating element according to an embodiment of the invention;

FIG. 4 depicts zones of a fluid ejection head, according to an embodiment of the invention;

FIGS. 5A-5I depict bit intensity word tables for various heating intensity levels of non-nucleating heating (NNH) according to an embodiment of the invention;

FIG. 6 depicts a chart comparing the number of zones activated for non-nucleating heating as a function of address cycle for various heat intensity levels according to an embodiment of the invention;

FIG. 7 depicts oscilloscope traces showing ground bounce caused by a large current applied to a fluid election head;

FIG. 8 depicts oscilloscope traces showing some effects of ground bounce on an internal clock signal;

FIG. 9 depicts an apparatus for staggering fire pulses provided to primitive groups in a fluid ejection head to prevent ground bounce according to an embodiment of the invention;

FIG. 10 depicts an example of staggered fire pulses generated by the apparatus of FIG. 9;

FIG. 11 depicts oscilloscope traces showing an example of simultaneous NNH current pulses applied to two primitive groups, wherein the combined high NNH current of the two pulses causes distortion of the internal color clock signal; and

FIG. 12 depicts oscilloscope traces showing an example of a first NNH current pulse applied to one primitive group and a second NNH current pulse applied to another primitive group after a time delay.

### DETAILED DESCRIPTION

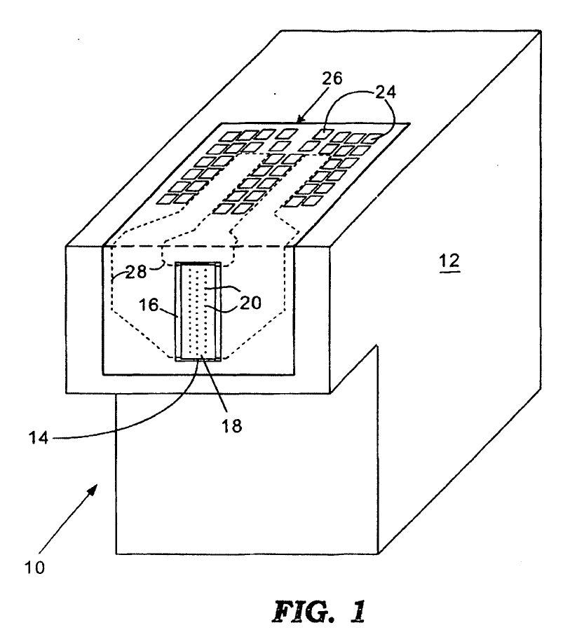

With reference to FIG. 1, a fluid cartridge 10 for a microfluid ejection device is illustrated. The cartridge 10 includes a cartridge body 12 for supplying a fluid to a fluid ejection head 14. The fluid may be contained in a storage area in the cartridge body 12 or may be supplied from a remote source.

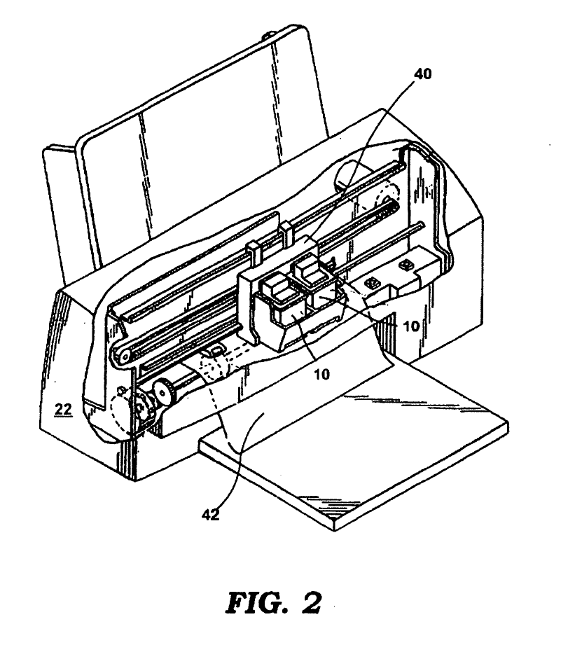

The fluid ejection head 14 includes a semiconductor substrate 16 and a nozzle plate 18 containing nozzle holes 20. The cartridge may be removably attached to a micro-fluid ejection device such as an ink jet printer 22 (FIG. 2). Accordingly, electrical contacts 24 are provided on a flexible circuit 26 for electrical connection to the microfluid ejection device. The flexible circuit 26 includes electrical traces 28 that are connected to the substrate 16 of the fluid ejection head 14.

An enlarged view, not to scale, of a portion of the fluid ejection head 14 is illustrated in FIG. 3. In this ease, the fluid ejection head 14 contains a thermal heating element 30 as a fluid election actuator for heating the fluid in a fluid chamber 32 formed in the nozzle plate 18 between the substrate 16 and a nozzle hole 20. The heating elements 30 are heater resistors customarily having a protective layer comprising silicon nitride and tantalum with a thickness ranging from about 1000 to about 3000 Angstroms.

Fluid is provided to the fluid chamber 32 through an opening or via 34 in the substrate 16 and through a fluid channel 36 connecting the slot 34 with die fluid chamber 32. The nozzle plate 18 is often, adhesively attached to the substrate 16 as by adhesive layer 38. As depicted in FIG. 3, the flow features including the fluid chamber 32 and fluid channel 36 are formed in the nozzle plate 18. However, the flow features may be provided in a separate thick film layer and wherein a nozzle plate containing only nozzle holes is attached to the thick film layer. In one embodiment, the fluid ejection head 14 is a thermal inkjet printhead. However, the invention is not intended, to be limited to ink jet printheads as other fluids may be ejected with a microfluid ejection device according to the invention.

Referring again to FIG. 2, the fluid ejection device may be an ink jet printer 22. The printer 22 includes a carriage 40 for holding one or more cartridges 10 and for moving the cartridges 10 over a media 42, such as paper, while a fluid from the cartridges 10 is deposited on the media 42. As set forth above, the contacts 24 on the cartridge mate with contacts on the carriage 40 for providing electrical connection between the printer 22 and the cartridge 10. Microcontrollers in the printer 22 control the movement of the carriage 40 across the media 42 and convert analog and/or digital inputs from an external device such as a computer for controlling the operation of the printer 22. Ejection of fluid from the fluid ejection head 14 is controlled by a logic circuit on the fluid ejection head 14 in conjunction with the controller in the printer 22.

As discussed above, it is desirable to preheat the fluid ejection head 14 to a predetermined operating temperature before the head 14 is used in a printing operation. In some embodiments of the invention, this is done using the “Non-Nucleating Heating” (NNH) technique. With NNH, an electrical pulse is applied to the heating element 30 having a duration which is too short to generate enough beat to eject ink, but which is sufficient to heat the substrate 16 at an acceptable rate to achieve the desired operating temperature within an acceptable amount of time.

To apply NNH to control the temperature of the fluid ejection head 14, the intensity of the applied heat must be modulated in a way that allows for closed-loop control, of the temperature. In some embodiments of the invention, the heating intensity is modulated using a binary intensity word (BIW) wherein each bit in the word is associated with an address of a group of heating elements 30 of the fluid ejection bead 14. When all of the bits of the BIW are active (ON or 1), the resulting heat intensity is 100%. When all of the bits of the BIW are inactive (OFF or 0), the resulting heat intensity is 0%. When any other number of bits in the BIW are active, the heat intensity (HI) is determined by the number of ON-bits (a) divided by the total number of bits (w):

HI=a/w×100%

As discussed in the Background section, it is desirable to apply uniform heating across the fluid ejection head 14. In one embodiment of the invention, this is accomplished by using a BIW having a width in bits, w, that is some number other than the number of addresses, p, used in the fluid ejection head 14. For example, the if ten addresses are used in the addressing scheme, the BIW may have nine bits or eleven bits. Table I below illustrates an example wherein there are ten addresses and the BIW comprises nine bits.

TABLE I

| | Address | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| | 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 |
| BIW | 1 | 0 | 0 | 0 | 0 | 1 | 0 | 0 | 0 | 1 | 0 | 0 | 0 | 0 | 1 | 0 | 0 | 0 | 1 | 0 | 0 | 0 | 0 | 1 | 0 | 0 | 0 | 1 | 0 | 0 |

As shown in Table I, addresses 1, 6 and 0 are energized for NNH heating during the first address cycle. During the second address cycle, addresses 5 and 9 are energized. During the third address cycle, addresses 4 and 8 are energized. After nine consecutive address cycles, the sequence repeats. This provides a balanced application of the desired heating intensity across the fluid ejection head during multiple address cycles.

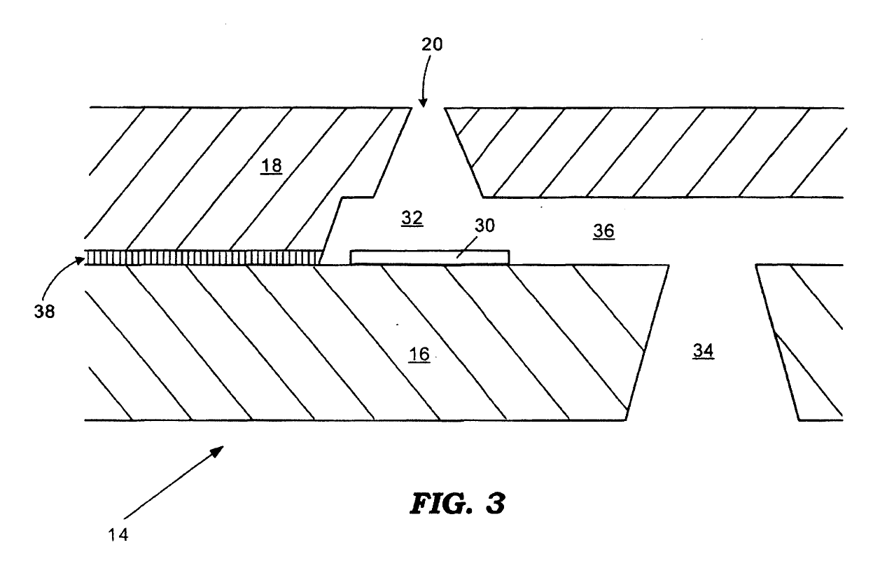

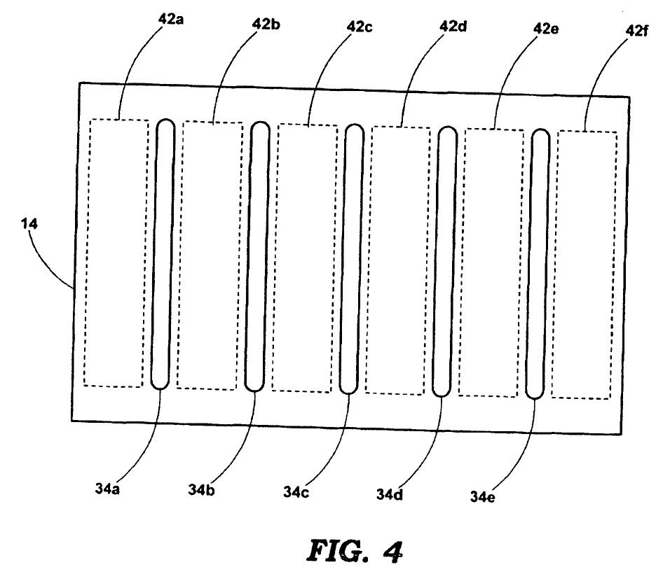

In some fluid ejection heads, the heating elements 30 and nozzles 20 are arranged in multiple zones. FIG. 4 depicts a fluid ejection head 14 having six zones 42a-42f separated by five ink vias 34a-34e. When a fluid ejection head includes multiple zones, some embodiments of the invention use multiple BIW's, where each zone has a unique BIW assigned thereto. Table II below illustrates an example of a BIW table for a fluid ejection head having six zones.

TABLE II

| | Address | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| | 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 |
| BIW | 1 | 0 | 0 | 0 | 1 | 0 | 0 | 0 | 0 | 1 | 0 | 0 | 0 | 1 | 0 | 0 | 0 | 0 | 1 | 0 | 0 | 0 | 1 | 0 | 0 | 0 | 0 | 1 | 0 | 0 |
| 1 | | | | | | | | | | | | | | | | | | | | | | | | | | | | | | |
| BIW | 0 | 1 | 0 | 0 | 0 | 1 | 0 | 0 | 0 | 0 | 1 | 0 | 0 | 0 | 1 | 0 | 0 | 0 | 0 | 1 | 0 | 0 | 0 | 1 | 0 | 0 | 0 | 0 | 1 | 0 |
| 2 | | | | | | | | | | | | | | | | | | | | | | | | | | | | | | |
| BIW | 0 | 0 | 0 | 1 | 0 | 0 | 0 | 1 | 0 | 0 | 0 | 0 | 1 | 0 | 0 | 0 | 1 | 0 | 0 | 0 | 0 | 1 | 0 | 0 | 0 | 1 | 0 | 0 | 0 | 0 |
| 3 | | | | | | | | | | | | | | | | | | | | | | | | | | | | | | |
| BIW | 0 | 0 | 1 | 0 | 0 | 1 | 0 | 0 | 0 | 0 | 0 | 1 | 0 | 0 | 1 | 0 | 0 | 0 | 0 | 0 | 1 | 0 | 0 | 1 | 0 | 0 | 0 | 0 | 0 | 1 |
| 4 | | | | | | | | | | | | | | | | | | | | | | | | | | | | | | |
| BIW | 0 | 0 | 0 | 0 | 0 | 0 | 1 | 0 | 1 | 0 | 0 | 0 | 0 | 0 | 0 | 1 | 0 | 1 | 0 | 0 | 0 | 0 | 0 | 0 | 1 | 0 | 1 | 0 | 0 | 0 |
| 5 | | | | | | | | | | | | | | | | | | | | | | | | | | | | | | |
| BIW | 0 | 0 | 0 | 0 | 0 | 0 | 0 | 1 | 1 | 0 | 0 | 0 | 0 | 0 | 0 | 0 | 1 | 1 | 0 | 0 | 0 | 0 | 0 | 0 | 0 | 1 | 1 | 0 | 0 | 0 |
| 6 | | | | | | | | | | | | | | | | | | | | | | | | | | | | | | |

The BIW's applied as shown in Table II result in a heating intensity of about 22%. Note that the active addresses are spread evenly over time and no more than two zones are simultaneously active during any address window. To fully appreciate the advantage of this scheme, note the difference between Table II and Table III. In Table III, each zone has the same BIW which results in the application of NNH to all zones of the fluid ejection heater chip simultaneously during certain address windows. Since NNH heating is applied to all non-printing heating elements within the activated address windows, large amounts of current flow through the chip during these address windows. As discussed above, such large current loads can be detrimental to the operation of the heater chip.

TABLE III

| | Address | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| | 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 1 | | | | | | | | | | | | | | | | | | | | | | | | | | | | | | |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 2 | | | | | | | | | | | | | | | | | | | | | | | | | | | | | | |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 3 | | | | | | | | | | | | | | | | | | | | | | | | | | | | | | |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 4 | | | | | | | | | | | | | | | | | | | | | | | | | | | | | | |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 5 | | | | | | | | | | | | | | | | | | | | | | | | | | | | | | |
| BIW | 1 | 0 | 0 | 0 | 1 | 0 | 0 | 0 | 0 | 1 | 1 | 0 | 0 | 0 | 1 | 0 | 0 | 0 | 0 | 1 | 1 | 0 | 0 | 0 | 1 | 0 | 0 | 0 | 0 | 1 |
| 6 | | | | | | | | | | | | | | | | | | | | | | | | | | | | | | |

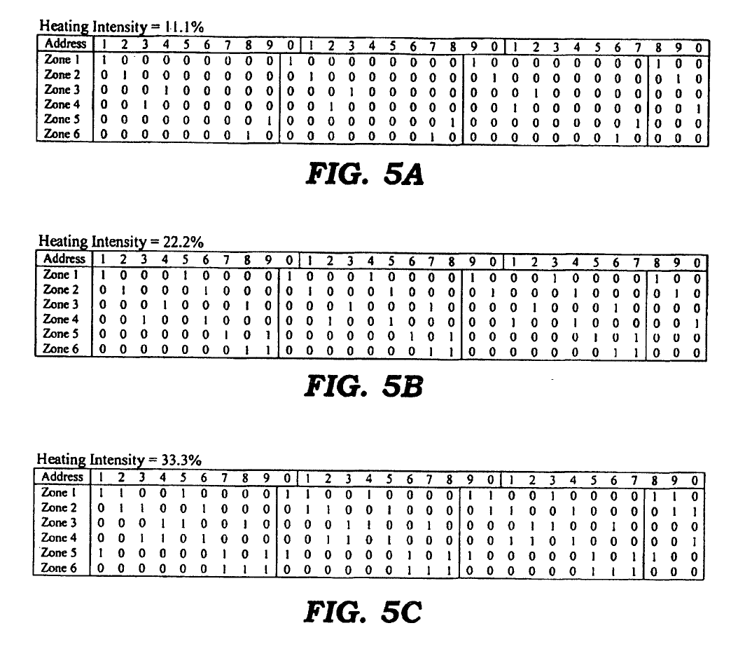

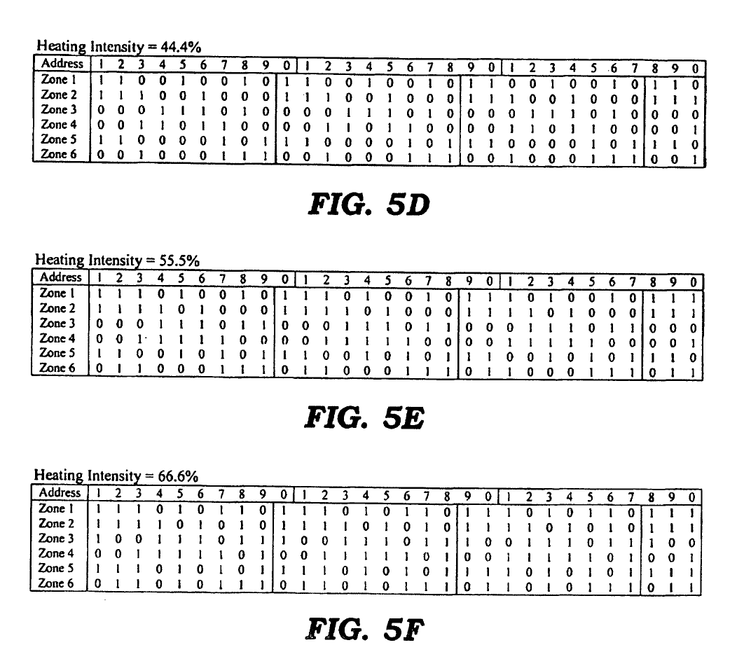

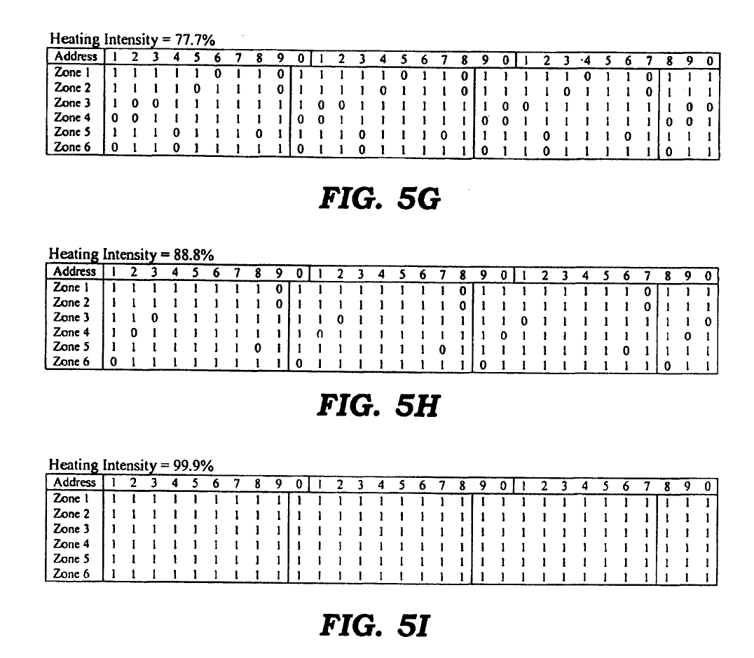

FIGS. 5A-5I depict examples of BIW tables for a six-zone (n=6). ten-address (m=10) fluid ejection head for 11%, 22%, 33%, 44%, 55%, 66%, 77%, 88% and 99% heating intensity levels. Those skilled in me art will appreciate that a BIW table for 0% heating intensity (not shown) will comprise all zeros.

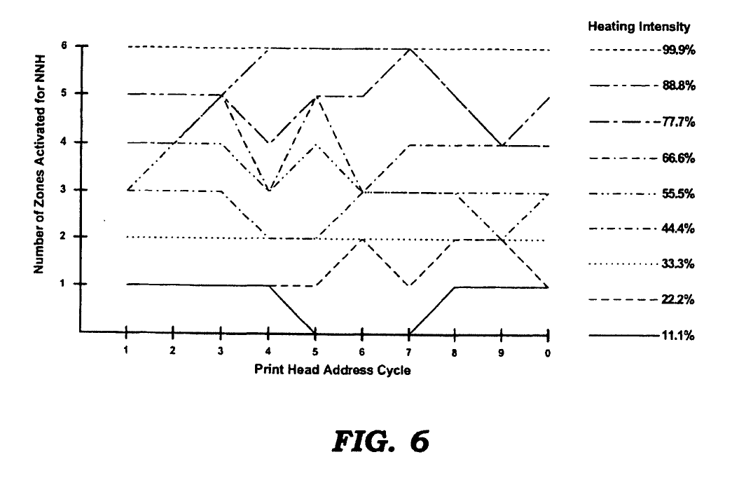

FIG. 6 depicts the number of zones activated tor NNH heating as a function of address cycles for each of the heating intensity levels based on the BIW tables depicted in FIGS. SA-5I.

Another consideration in determining the BIW for each zone is the number of heating elements that have NNH applied in a particular zone. In some embodiments of the invention, the zones of the fluid ejection head may have a different number of heating elements available for NNH heating. For example with reference to FIG. 4, zones 42a and 42f, which are on the outer edges of the heater chip 14, may contain only one array of heating elements, and may have only eight heating elements available for NNH heating. Zones 42b-42e, which are on the interior of the chip 14, may each have two arrays of heating elements, and sixteen of the elements may be available for NNH heating. According to some embodiments of the invention, the interior zones 42b-42e, are not activated for NNH heating simultaneously to avoid high peak current levels. The BIW table can be setup for NNH heating in such a way that each location in the table is balanced in regard to which zones, and the total number of heating heaters, that are simultaneously selected. Accordingly, as illustrated, in Table II, activation of the low-density zones (rows BIW1 and BIW6) is interspersed with the activation of the high-density zones (rows BIW2-BIW5) to balance out the maximum currents as the rotation proceeds through the ten address windows.

Reducing Peak Currents During Printing or NNH Operations

As discussed in the Background section, the voltage across the inductance of the connections to the fluid ejection heater chip may be expressed as:

v=L(di/dt).

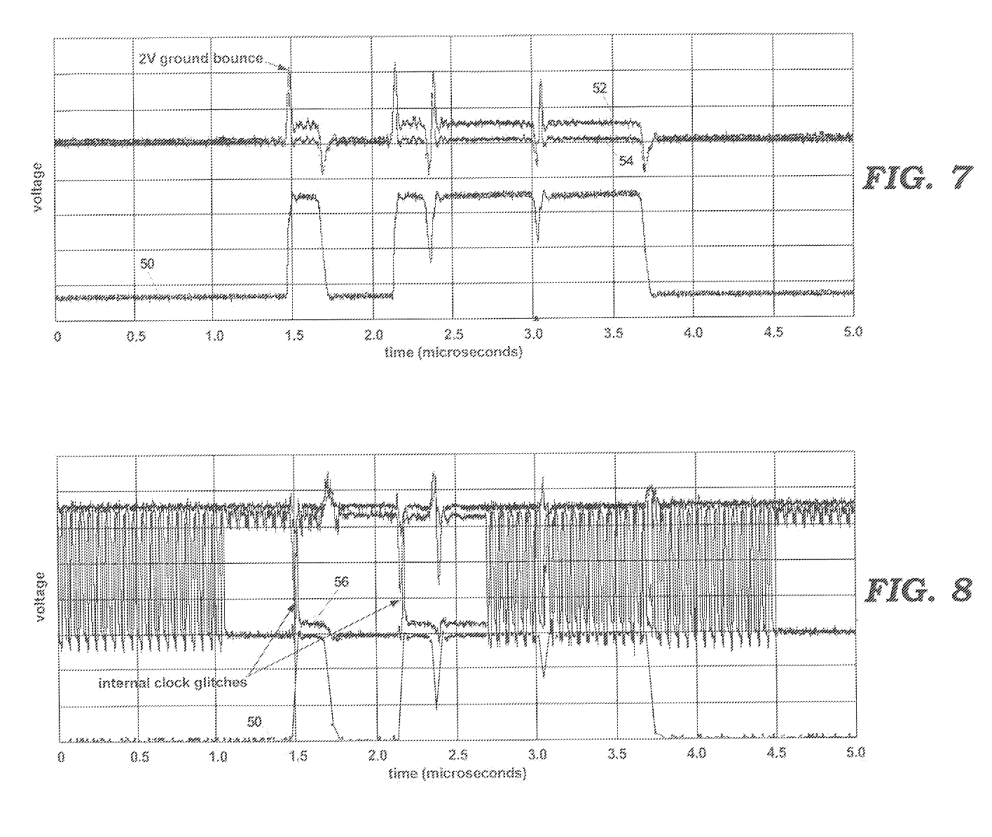

As the current, rise-time decreases, di/dt increases, and the voltage across the inductance increases which produces a sharp positive voltage spike (ground bounce) at the ground input of the chip. (See FIGS. 7 and 8.)

For a current having a fixed rise time, the only way to decrease di/dt is to spread the change in current out over time. According to one embodiment of the invention, this is done by adding a slight time delay between the heating element activation inputs for each successive primitive group. For example, the fluid ejection head, of an ink jet printer may have sixteen primitive fire groups (P1-P16), each comprising 40 heating elements. Generally, it is possible to fire only one heating element per primitive during a given address window. These sixteen primitive groups may be split between, left and right heater element arrays for each color, with primitive groups P1-P8 assigned to the left side heaters and primitive groups P9-P16 assigned to the right side heaters. For primitive groups P1-P8, a delay is introduced between P1 and P2, between P2 and P3, between P3 and P4, and so on for the extent of the heater array. This causes subsequent heating elements to fire slightly after the heating element preceding it, thereby spreading the current out over time. In an embodiment, the firing delay between primitive groups is on the order of five nanoseconds (ns). From a dot misplacement perspective, this firing delay is inconsequential. However, it has a pronounced effect on di/dt and ground bounce.

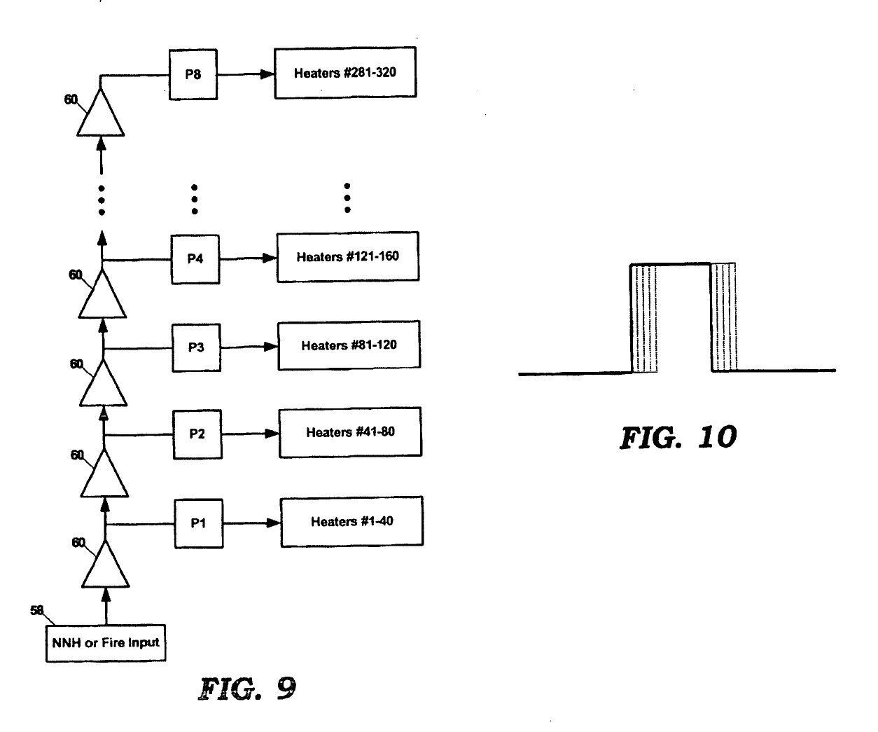

In an embodiment of the invention, eight primitive groups (i.e., P1-P8) and delay buffers 60 are arranged according to the format depicted in FIG. 9. With approximately 5 ns delay between each of the eight primitive groups in the heating element array, the total delay horn the top to the bottom of the array is on the order of 35-40 ns. As shown in FIG. 10, the heating element current pulses have a ripple effect in how they are activated.

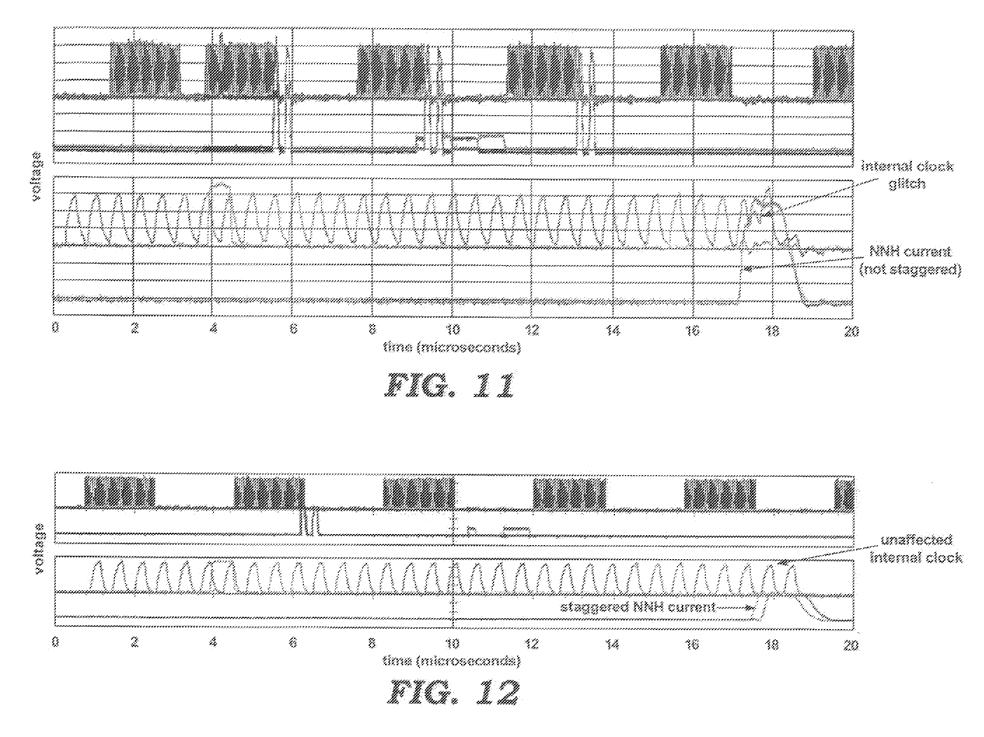

FIG. 11 depicts oscilloscope traces showing an example of simultaneous NNH current, pulses applied to two primitive groups. The resulting high NNH current causes the internal color clock signal to be distorted. As a result, the edge of the clock pulse is not distinct and is missed. This delays the data being loaded into the primitive data register which causes the wrong heating element to fire.

FIG. 12 depicts the benefit of staggering the NNH current pulses in time. In this example, a first NNH current pulse is applied to one primitive group and a second NNH current pulse is applied to another primitive group after a 5 ns delay. As shown in FIG. 12, this results in less ground bounce and the internal clock signal is not affected.

Prior inkjet print head devices have implemented staggered timing of ink fire pulses for the purpose of reducing EMI generated by the firing signals. For example, U.S. Pat. No. 6,375,295 (the '295 patent) describes the staggering of ink fire pulses to reduce EMI. However, the '295 patent does not describe the staggering of non-firing pulses, such as NNH pulses, used in maintaining the substrate temperature. In fact, since NNH current pulses have a much shorter duration than ink firing pulses, EMI is of less concern with NNH heating systems as described herein. Thus, the '295 patent provides no suggestion of staggering the timing of NNH pulses.

The foregoing description of various embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within fee scope of fee invention as determined by the appended claims when interpreted in accordance with the breadth to which they are fairly, legally, and equitably entitled.

What is claimed is:

1. A method for controlling temperature of a fluid ejection head in a fluid ejection apparatus, wherein the fluid ejection head includes a plurality of heating elements for generating fluid-nucleating heat for fluid ejection purposes and for generating non-fluid-nucleating heat for temperature control purposes, wherein the heating elements are disposed in n number of zones distributed across the fluid ejection head and are assigned to m number of address groups, wherein each address group is activated during a corresponding address window, the method comprising;
(a) generating n number of bit intensity words to specify an activation sequence for activating the m number of address groups of heating elements for generating non-fluid-nucleating heat, each bit intensity word having a width of w number of bits, wherein each bit of the bit intensity word controls the activation of a corresponding address group during the corresponding address window, and wherein high or low states of each bit in each of foe bit intensity words are determined so that the address groups activated during the address windows are distributed over the zones of the fluid ejection head to substantially balance the distribution of electrical current applied for non-fluid-nucleating heating across the zones; and
(b) activating the address groups of heating elements according to the sequence specified by the n number of bit intensity words to generate non-nucleating heat in the fluid ejection head.

2. The method of claim 1 wherein, w is not equal to m.

3. The method of claim 1 further comprising generating the n number of bit intensity words to provide the non-fluid-nucleating heat at a heating intensity level according to:
$$HI = \frac{a}{w} \times 100 \% .$$
where a is a number of bits in a high state and w is the width, of each bit intensity word.

4. The method of claim 3 wherein no mom than one zone is activated during any one address window at heating intensity levels of about 11% or less.

5. The method of claim 3 wherein no more than two zones are activated during any one address window at heating intensity levels of about 33% or less.

6. The method of claim 3 wherein no more than three zones are activated during any one address window at heating intensity levels of about 44% or less.

7. The method of claim 3 wherein no more than four zones are activated during any one address window at heating intensity levels of about 56% or less.

8. The method of claim 3 wherein no more than five zones are activated during any one address window at heating intensity levels of about 67% or less.

9. The method of claim 1 wherein the heating elements are assigned to p number of primitive groups, and step (b) includes activating the primitive groups for non-nucleating heating in a predetermined sequence with a time delay between the activation of each primitive group.

10. A method for controlling the temperature of a fluid ejection head in a fluid ejection apparatus, wherein the fluid ejection head includes a plurality of heating elements for generating fluid-nucleating heat for fluid ejection, purposes and for generating non-fluid-nucleating heat for temperature control purposes, wherein the heating elements are assigned to p number of primitive groups, and all of the primitive groups are activated to generate non-fluid-nucleating heat by a single non-nucleating heating activation signal, the method comprising:
(a) generating the non-nucleating heating activation signal for producing non-fluid-nucleating heat in the fluid ejection head; and
(b) providing a time delay in the non-nucleating heating activation signal between each primitive group so that the primitive groups are activated by the non-nucleating heating activation signal sequentially rather than, simultaneously, thereby reducing peak current applied to the fluid ejection head and the corresponding detrimental effects of ground bounce.

11. The method of claim 10 wherein the time delay is approximately five nanoseconds.

12. An apparatus for controlling the temperature of a fluid ejection head in a fluid ejection device, the apparatus comprising:
a plurality of heating elements for generating fluid-nucleating heat for fluid ejection purposes and for generating non-fluid-nucleating heat for temperature control purposes, wherein the heating elements are distributed into p number of primitive groups;
p number of activation signal lines, each connected to a corresponding one of the p number of primitive groups of heating elements; and
a non-nucleating heating activation input connected to the p number of activation signal lines, the non-nucleating heating activation input for receiving an activation signal which causes activation of the heating elements to produce non-fluid-nucleating heat in the fluid ejection head:
a plurality of delay buffers, wherein at least one delay buffer is provided between each of the activation signal lines, each delay buffer providing a time delay in the activation signal, between each primitive group so that the primitive groups are activated by the activation signal sequentially rather than simultaneously, thereby reducing peak current applied to the fluid ejection head and the corresponding detrimental effects of ground bounce.
